(19) United States
(12) Patent Application Publication
(10) Pub. No.: US 2026/0124784 A1
(43) Pub. Date: May 7, 2026

(54) A METHOD FOR MANUFACTURING A CELLULOSE PRODUCT AND A CELLULOSE PRODUCT

(71) Applicant: PULPAC AB, Västra Fröhunda (SE)

(72) Inventors: Ove Larsson, Västra Fröhunda (SE); Philip FAWCUS, Västra Fröhunda (SE); Mark JONES, Västra Fröhunda (SE); Mark FARRELL, Västra Fröhunda (SE); Stuart DUNLOP, Västra Fröhunda (SE)

(21) Appl. No.: 18/706,349

(22) PCT Filed: Oct. 31, 2022
(86) PCT No.: PCT/EP2022/080354

§ 371 Date: Apr. 30, 2024

(30) Foreign Application Priority Data
Nov. 5, 2021 (SE) 2151359-3

(51) Int. Cl. B27N 7/00; B05D 7/22; B27N 3/12; B27N 3/20; B27N 5/02; B65D 25/14; B65D 25/36; D21J 3/10

(52) U.S. Cl. CPC B27N 7/005; B05D 7/227; B27N 3/12; B27N 3/203; B27N 5/02; B65D 25/14; B65D 25/36; D21J 3/10; B05D 2203/22

(57) ABSTRACT

A cellulose product comprising a non-flat cellulose product structure, a protective inner layer, and a protective outer layer. The cellulose product structure comprises an interior surface, an exterior surface, and an edge structure arranged between the interior surface and the exterior surface. The protective inner layer is applied to the interior surface, and the protective outer layer is arranged in connection to the exterior surface of the cellulose product structure. The protective inner layer and the protective outer layer are forming an integrated structure that is fully enclosing the cellulose product structure, and a sealed outer volume is formed by the protective inner layer and the protective outer layer.

### TECHNICAL FIELD

The present disclosure relates to a method for manufacturing a cellulose product. The disclosure further relates to a cellulose product comprising a non-flat cellulose product structure.

### BACKGROUND

Cellulose fibres are often used as raw material for producing or manufacturing cellulose products. Products formed of cellulose fibres can be used in many different situations where there is a need for having sustainable products. A wide range of cellulose products can be produced from cellulose fibres and a few examples are disposable bowls and cups used for holding and storing for example food, beverages, or other types of liquid substances and goods.

One common drawback with products made of cellulose fibres is the ability to absorb moisture from the surrounding environment. When absorbing moisture, the structural rigidity of the cellulose products is decreased, and the products may become unstable and not suitable for holding goods anymore. This may happen if the products are used in environments with high humidity or if being exposed to water. If the cellulose products, such as cups, are used for holding liquids for short-time use, the cellulose fibres may be mixed with plastic materials or a plastic film layer is applied to the inner side of the products to withstand the impact from the liquids. However, today for products demanding longer times for storage, such as liquids or food where there is a need for longer shelf-times, other materials than cellulose fibres are used. Instead, most packaging solutions are using plastic materials or metals to avoid the drawbacks with non-rigid and unstable cellulose products.

There is thus a need for an improved and more environmentally friendly solution, where recyclable products containing cellulose fibres can be used for holding food, beverages, or other types of liquid substances and goods for longer periods, allowing long shelf-times during transportation, storage, and sales.

### SUMMARY

An object of the present disclosure is to provide a method for manufacturing a cellulose product and a cellulose product where the previously mentioned problems are avoided. This object is at least partly achieved by the features of the independent claims. The dependent claims contain further developments of the method for manufacturing a cellulose product and the cellulose product.

The disclosure concerns a method for manufacturing a cellulose product. The method comprises the steps: providing a non-flat cellulose product structure, where the cellulose product structure comprises an interior surface, an exterior surface, and an edge structure arranged between the interior surface and the exterior surface; applying a protective inner layer to the interior surface; and arranging a protective outer layer in connection to the exterior surface of the cellulose product structure, where the protective inner layer and the protective outer layer are forming an integrated structure that is fully enclosing the cellulose product structure, and where a sealed outer volume is formed by the protective inner layer and the protective outer layer.

Advantages with these features are that the method is providing an efficient solution for producing environmentally friendly and recyclable cellulose products, where the products can be used for holding food, beverages, or other types of liquid substances and goods for longer periods, allowing long shelf-times during transportation, storage, and sales. The sealed outer volume formed by the protective inner layer and the protective outer layer is efficiently preventing the cellulose product structure from moisture, and the construction of the cellulose product is thus preventing the cellulose fibres of the cellulose product structure from absorbing moisture from the surrounding environment. The solution is maintaining the structural rigidity of the cellulose products even if being exposed to moisture or liquids, for example in environments with high humidity or if being exposed to water. The protective inner layer and the protective outer layer may be removed from the cellulose product structure for an efficient recycling of materials used. The protective layers may be separated from the cellulose product structure for example by peeling off the protective layers from the cellulose product structure. After the removal of the protective layers from the cellulose product structure, the cellulose product structure can be recycled as a paper product (PAP) and the protective layers for example as plastic materials. As an alternative, the protective inner layer and the protective outer layer are made of materials that can be recycled with the cellulose product structure.

In certain embodiments, the method further comprises the steps: providing an air-formed cellulose blank structure and feeding the cellulose blank structure to a forming mould; forming the non-flat cellulose product structure from the cellulose blank structure in the forming mould by heating the cellulose blank structure to a forming temperature, and pressing the cellulose blank structure with a forming pressure, wherein the cellulose product structure during forming is shaped with the interior surface, the exterior surface, and the edge structure arranged between the interior surface and the exterior surface. With this method, the cellulose product structure is dry formed in the forming mould from the air-formed cellulose blank structure. The forming pressure and the forming temperature are enabling the forming of a cellulose product structure with high structural rigidity. The cellulose product structure may be formed from the cellulose blank structure in the forming mould by heating the cellulose blank structure to a forming temperature in the range of 100-300° C., preferably in the range of 100-200° C., and pressing the cellulose blank structure with a forming pressure in the range of 1-100 MPa, preferably in the range of 4-20 MPa. This dry-forming operation is providing an efficient and environment friendly forming process, where the amount of energy used in the forming process is lower compared to wet-formed structures. The dry-forming process is also enabling short production lead times, since the cellulose product structure is instantly formed in the forming mould without the need for drying or further forming steps.

In an alternative embodiment, the method further comprises the steps: applying the protective inner layer to the interior surface and/or the protective outer layer to the exterior surface during forming of the non-flat cellulose product structure from the cellulose blank structure in the forming mould. By application of the protective layer or layers during forming in the forming mould, an efficient forming process is achieved without any need for subsequent applications steps for the protective layer or layers.

One or more substances may alternatively be applied through liquid application and/or sputter deposition to the cellulose blank structure before forming of the non-flat cellulose product structure from the cellulose blank structure in the forming mould. The protective inner layer is formed onto the interior surface and/or the protective outer layer is formed onto the exterior surface from the applied one or more substances during forming of the non-flat cellulose product structure from the cellulose blank structure in the forming mould. The protective layer or layers are thus formed during the dry-forming process in the forming mould.

In one embodiment, the protective inner layer and the protective outer layer are formed by a single material sheet. The method further comprises the steps: applying the single material sheet to the interior surface for forming the protective inner layer, and applying the single material sheet around the exterior surface and the edge structure for forming the protective outer layer. With these method steps, the same sheet of material is used for both the protective inner layer and the protective outer layer. This is for example useful if the same material properties of the protective inner layer and the protective outer layer are desired. The protective inner layer may be applied to the interior surface and the protective outer layer may be applied around the exterior surface as additional steps after forming of the cellulose product structure in the forming mould.

In a yet further alternative embodiment, the protective inner layer is formed by a first material sheet and the protective outer layer is formed by a second material sheet. The method further comprises the steps: applying the first material sheet to the interior surface for forming the protective inner layer; applying the second material sheet around the exterior surface for forming the protective outer layer; and attaching the protective outer layer to the protective inner layer. With this configuration of the cellulose product, two different layer structures are used for the protective inner layer and the protective outer layer. This is for example useful if different material properties of the protective inner layer and the protective outer layer are desired.

In further alternative embodiments, the method further comprises the steps: forming the protective inner layer through liquid application or sputter deposition of a material sheet onto the interior surface, and/or forming the protective outer layer through liquid application or sputter deposition of a material sheet onto the exterior surface. In this way, the cellulose product structure is treated with a substance through the liquid application and/or sputter deposition for forming the protective layer or layers.

According to an embodiment, the method further comprises the steps: attaching and sealing a protective cover layer to a part of the protective inner layer and/or a part of the protective outer layer, where an enclosed and sealed inner storage volume is formed between the protective cover layer and the protective inner layer. The protective cover layer is in this way forming a lid structure of the cellulose product. The protective cover layer can be removably attached to a part of the protective inner layer and/or a part of the protective outer layer such that the protective cover layer can be removed from the cellulose product without jeopardizing the function of the protective layers.

According to an embodiment, the interior surface with the applied protective inner layer is forming a filling cavity. The method further comprises the step: filling the filling cavity with a filling substance before attaching and sealing the protective cover layer to the protective inner layer and/or the protective outer layer. The filling cavity is arranged for holding food, beverages, or other types of liquid or dry substances and goods for longer periods.

According to an embodiment, the method further comprises the steps: attaching and sealing a protective cover layer to a part of the protective inner layer, wherein the protective cover layer is formed by the second material sheet, wherein an enclosed and sealed inner storage volume is formed between the protective cover layer and the protective inner layer. The protective cover layer is in this way forming a lid structure of the cellulose product.

According to an embodiment, the interior surface with the applied protective inner layer is forming a filling cavity. The method further comprises the step: filling the filling cavity with a filling substance before attaching and sealing the protective cover layer to the protective inner layer. The filling cavity is arranged for holding food, beverages, or other types of liquid substances and goods for longer periods.

In a further embodiment, the method further comprises the step: at least partly adhering the protective inner layer to the interior surface when applying the protective inner layer to the interior surface.

The disclosure further concerns a cellulose product comprising a non-flat cellulose product structure, a protective inner layer, and a protective outer layer. The cellulose product structure comprises an interior surface, an exterior surface, and an edge structure arranged between the interior surface and the exterior surface. The protective inner layer is applied to the interior surface, and the protective outer layer is arranged in connection to the exterior surface of the cellulose product structure. The protective inner layer and the protective outer layer are forming an integrated structure that is fully enclosing the cellulose product structure, and a sealed outer volume is formed by the protective inner layer and the protective outer layer.

Advantages with these features are that the cellulose products are environmentally friendly and recyclable, where the products are suitable for holding food, beverages, or other types of liquid substances and goods for longer periods, allowing long shelf-times during transportation, storage, and sales. The sealed outer volume formed by the protective inner layer and the protective outer layer is efficiently preventing the cellulose product structure from moisture, and the construction of the cellulose product is thus preventing the cellulose fibres of the cellulose product structure from absorbing moisture from the surrounding environment. The solution is maintaining the structural rigidity of the cellulose products even if being exposed to moisture or liquids, for example in environments with high humidity or if being exposed to water. The protective inner layer and the protective outer layer may be removed from the cellulose product structure for an efficient recycling of materials used. The protective layers may be separated from the cellulose product structure for example by peeling off the protective layers from the cellulose product structure. After the removal of the protective layers from the cellulose product structure, the cellulose product structure can be recycled as a paper product (PAP) and the protective layers for example as plastic materials. The protective inner and outer layers may alternatively be made of materials that can be recycled together with the cellulose product structure.

In one embodiment, the non-flat cellulose product structure is dry-formed from an air-formed cellulose blank structure. With this configuration, the cellulose product structure is suitably dry-formed in a forming mould from the air-formed cellulose blank structure. High forming pressure and forming temperature are enabling the forming of a cellulose product structure with high structural rigidity. The cellulose product structure may be dry-formed from the cellulose blank structure in the forming mould by heating the cellulose blank structure to a forming temperature in the range of 100-300° C., preferably in the range of 100-200° C., and pressing the cellulose blank structure with a forming pressure in the range of 1-100 MPa, preferably in the range of 4-20 MPa. The dry-forming is also providing environment friendly cellulose products due to low energy consumption in the forming process.

In one embodiment, the non-flat cellulose product structure is wet-formed. Wet-forming may be used as an alternative to dry-forming, even though it consumes more water and energy. In some situations, depending on the design of the cellulose product structure the wet-forming process is an efficient way to produce the cellulose product structures.

In one embodiment, one or more structural parts of the non-flat cellulose product structure is dry-formed from an air-formed cellulose blank structure, and one or more structural parts of the non-flat cellulose product structure is wet-formed. In a further alternative, the cellulose product structure is partly made through dry-forming and partly through wet-forming, which may be suitable if the structures are having complex shapes.

In a further embodiment, the protective inner layer is liquid impermeable or fluid impermeable and/or the protective outer layer is liquid impermeable or fluid impermeable. With these configurations, the layers are efficiently protecting the cellulose product structure and the inner layer is further suitable for holding food, beverages, or other types of liquid substances and goods for longer periods.

In a further embodiment, the protective inner layer and/or the protective outer layer are arranged as a polymer film layer, a cellulose material layer, a layer formed through liquid application, or a sputter deposition layer.

In a further embodiment, the product further comprises an enclosed and sealed inner storage volume. The sealed inner storage volume is formed between a protective cover layer and the protective inner layer. The sealed inner storage volume is arranged for holding food, beverages, or other types of liquid substances and goods for longer periods. The sealed inner storage volume is forming an enclosed volume for efficient and hygienic storage. The protective cover layer is in this way forming a lid structure of the cellulose product. The protective cover layer can be removably attached to a part of the protective inner layer and/or a part of the protective outer layer such that the protective cover layer can be removed from the cellulose product without jeopardizing the function of the protective layers.

In a further embodiment, the cellulose product comprises a filling cavity formed by the protective inner layer and the interior surface, where the filling cavity is configured for receiving a filling substance. The filling cavity is arranged for holding food, beverages, or other types of liquid substances and goods for longer periods.

According to an embodiment, the protective inner layer and the protective outer layer are formed by a single material sheet. With this configuration of the cellulose product, the same sheet of material is used for both the protective inner layer and the protective outer layer. This is for example useful if the same material properties of the protective inner layer and the protective outer layer are desired.

According to an embodiment, the protective inner layer is formed by a first material sheet and the protective outer layer is formed by a second material sheet. With this configuration of the cellulose product, two different sheets of material are used for the protective inner layer and the protective outer layer. This is for example useful if different material properties of the protective inner layer and the protective outer layer are desired.

In a further embodiment, the protective outer layer is attached and sealed to the protective inner layer in connection to the edge structure, or at the edge structure.

In a further embodiment, the protective inner layer is at least partly adhered to the interior surface; or the protective inner layer is at least partly adhered to the interior surface and/or the edge structure.

According to an example embodiment and with reference to the above, the interior surface of the non-flat cellulose product structure delimits a filling cavity that can be used to store products, such as food products, beverages, or other types of liquid substances and goods, as well as food products or other products in solid form, for longer periods. When the protective inner layer is in the form of a sheet like material layer, the sheet like material layer can be drawn towards and/or pushed into the inner space to cover at least the interior surface. According to an example embodiment, the non-flat cellulose product structure is gas permeable allowing gas, for example air, to pass through the cellulose product structure from the interior surface to the exterior surface. This has the advantage that air or other gas is prevented from being trapped between the inner surface and the protective inner layer. The air or other gas can thus escape through the cellulose product structure. A further advantage is that the non-flat cellulose product structure can be arranged in connection to a negative pressure or vacuum device, such as a gas suction device, that applies a negative pressure or vacuum to at least a part of the exterior surface of the cellulose product structure in order to create a pressure gradient between the interior surface and the exterior surface. In this way, air or other type of gas confined between the protective inner layer and the interior surface passes from the interior surface to the exterior surface through the cellulose product structure. This has the effect that the protective inner layer is drawn close to the interior surface due to the negative pressure or vacuum established between the protective inner layer and the interior surface. According to one example, the protective inner layer is applied as a sheet like material over the filling cavity and heated to be softer and thus easier to change form from the sheet like material to a form that corresponds to the interior surface by use of the negative pressure described above.

### BRIEF DESCRIPTION OF DRAWINGS

The disclosure will be described in detail in the following, with reference to the attached drawings, in which

FIG. 1a-g show schematically, in perspective views, different steps for manufacturing a cellulose product from a non-flat cellulose product structure,

FIG. 2a-h show schematically, in cross-sectional side views, different steps for manufacturing the cellulose product from the non-flat cellulose product structure,

FIG. 3a-h show schematically, in cross-sectional side views, different steps for manufacturing a cellulose product from a non-flat cellulose product structure according to an alternative embodiment,

FIG. 4a-h show schematically, in cross-sectional side views, different steps for manufacturing a cellulose product from a non-flat cellulose product structure according to a further alternative embodiment, and

FIG. 5a-e show schematically, in side views, different embodiments of a pressing module with a forming mould for dry-forming the non-flat cellulose product structure from an air-formed cellulose blank structure.

### DESCRIPTION OF EXAMPLE EMBODIMENTS

Various aspects of the disclosure will hereinafter be described in conjunction with the appended drawings to illustrate and not to limit the disclosure, wherein like designations denote like elements, and variations of the described aspects are not restricted to the specifically shown embodiments, but are applicable on other variations of the disclosure.

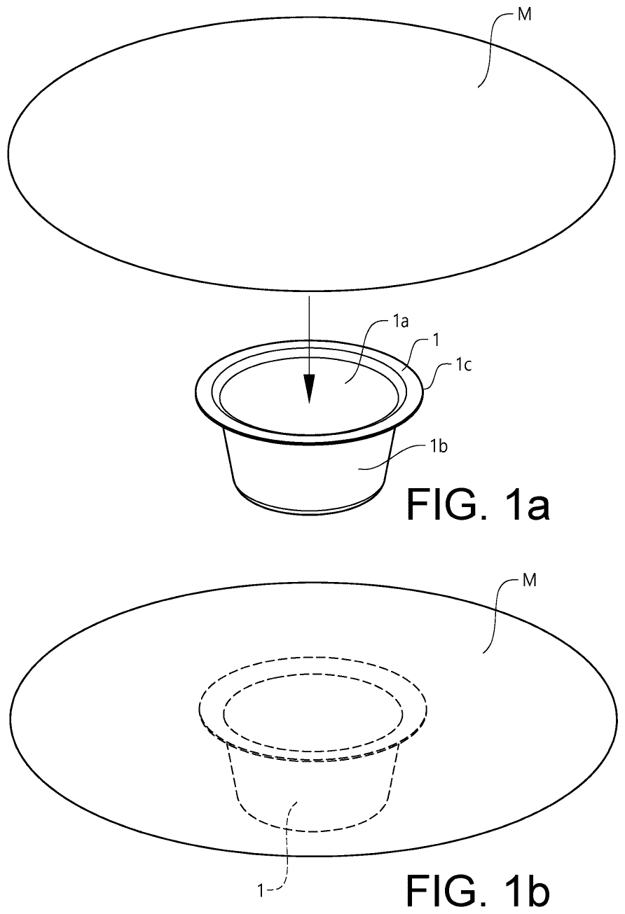

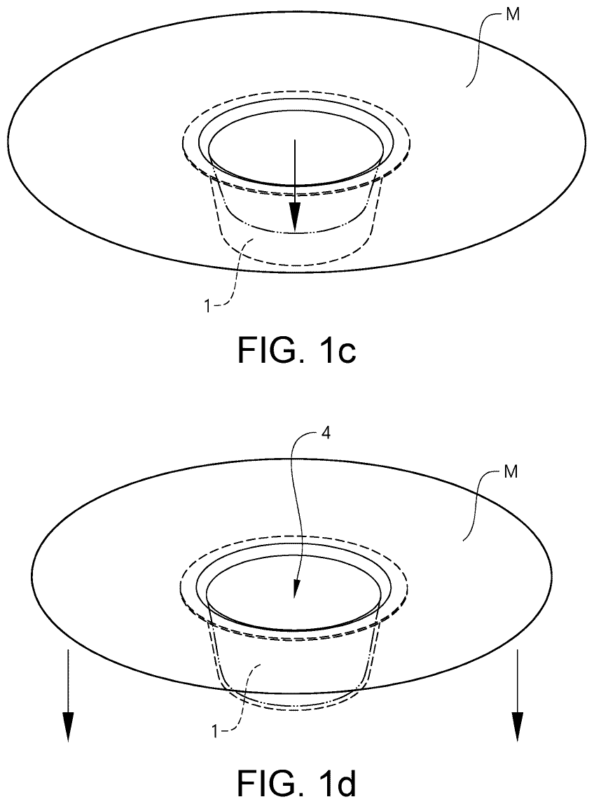

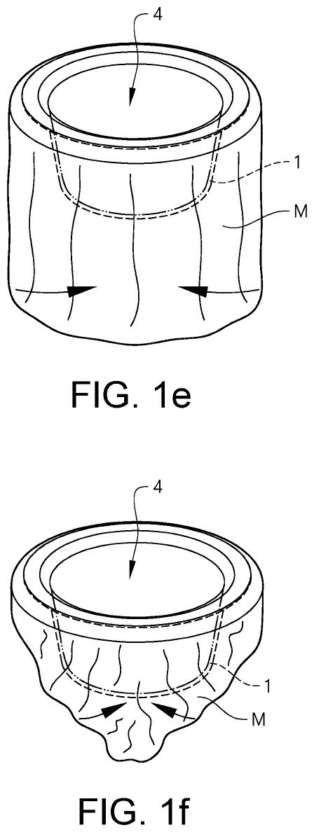

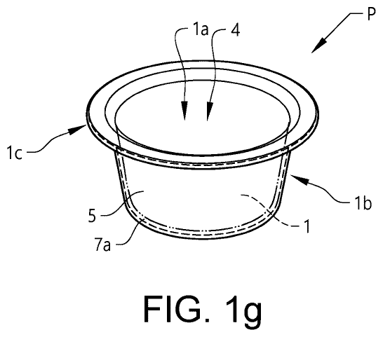

FIG. 1g schematically shows a cellulose product P. The cellulose product P comprises a non-flat cellulose product structure 1, a protective inner layer 4, and a protective outer layer 5. The cellulose product structure 1 is arranged with an interior surface 1a, an exterior surface 1b, and an edge structure 1c. The edge structure 1c is arranged between the interior surface 1a and the exterior surface 1b. The non-flat cellulose product structure 1 is forming a structural part of a cellulose product P. With a non-flat cellulose product structure is meant that the cellulose product structure has an extension in three dimensions, which is different from flat products like blanks or sheets. The non-flat cellulose product structure 1 is suitably arranged as a self-supporting body made of cellulose fibres, where the body has a rigid construction for holding a substance.

A desired property of the cellulose products P is the ability to hold or withstand liquids, such as for example when the cellulose products P are used in contact with beverages, food, and other liquid-containing substances. To prevent the cellulose product structure 1 from being in contact with the surrounding environment, the protective inner layer 4 is applied to the interior surface 1a of the cellulose product structure 1, and the protective outer layer 5 is arranged in connection to the exterior surface 1b of the cellulose product structure 1. Suitably, the protective outer layer 5 is arranged in connection to the exterior surface 1b of the cellulose product structure 1, as shown in FIGS. 1g, 2f, 3f, and 4h. As schematically illustrated in FIGS. 1g, 2f, 3f, and 4h, the protective inner layer 4 and the protective outer layer 5 are forming an integrated structure that is fully enclosing the cellulose product structure 1, and a sealed outer volume 7a is formed by the protective inner layer 4 and the protective outer layer 5. With this configuration of the cellulose product P, the cellulose product structure 1 is arranged within the sealed outer volume 7a, and thus fully encapsulated by the integrated structure formed by the protective inner layer 4 and the protective outer layer 5. The protective inner layer 4 and the protective outer layer 5 are securely attached and sealed to each other to form the sealed outer volume 7a, and the sealed outer volume 7a is suitably liquid impermeable or fluid impermeable to prevent liquids or fluids from coming into contact with the cellulose product structure 1 inside the sealed outer volume 7a. The protective inner layer 4 and the protective outer layer 5 are with this arrangement forming barrier layers, which are giving the cellulose products P the ability to hold or withstand liquids, such as for example when the cellulose products P are used in contact with beverages, food, and other liquid or fluid containing substances.

It should be understood that the expression the protective inner layer 4 is applied to the interior surface 1a, may include embodiments where the protective inner layer 4 partly or fully is adhered or attached to the interior surface 1a, or alternatively may include embodiments where the protective inner layer 4 is arranged in connection to, or partly or fully brought into contact with the interior surface 1a. In certain embodiments, the protective inner layer 4 is at least partly adhered to the interior surface 1a, or the protective inner layer 4 is at least partly adhered to the interior surface 1a and/or the edge structure 1b. The expression the protective outer layer 5 is arranged in connection to the exterior surface 1b, may include embodiments where the protective outer layer 5 is arranged around or wrapped around the exterior surface 1b, as well as embodiments where the protective outer layer 5 partly or fully is adhered or attached to the exterior surface 1b, or alternatively may include embodiments where the protective outer layer 5 is arranged in connection to, or partly or fully brought into contact with the exterior surface 1b. In certain embodiments, the protective outer layer 5 is at least partly adhered to the exterior surface 1b, or the protective outer layer 5 is at least partly adhered to the exterior surface 1b and/or the edge structure 1b.

In the embodiments illustrated in FIGS. 1a-g and 2a-h, the protective inner layer 4 and the protective outer layer 5 are formed by a single material sheet M. Thus, the single material sheet M is forming a common structure for both the protective inner layer 4 and the protective outer layer 5, as will be further described below.

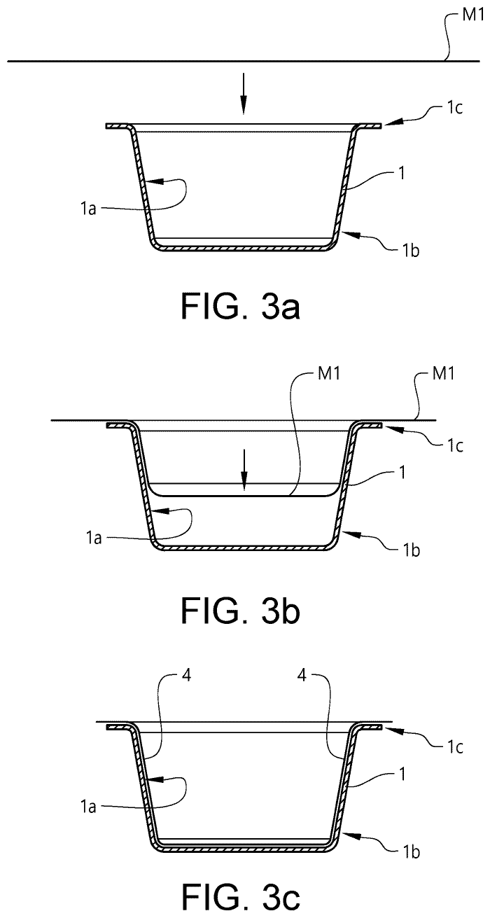

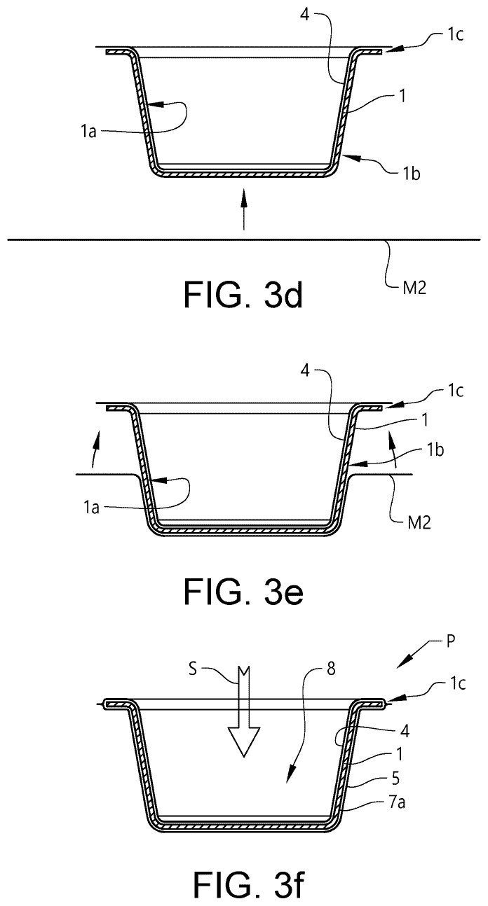

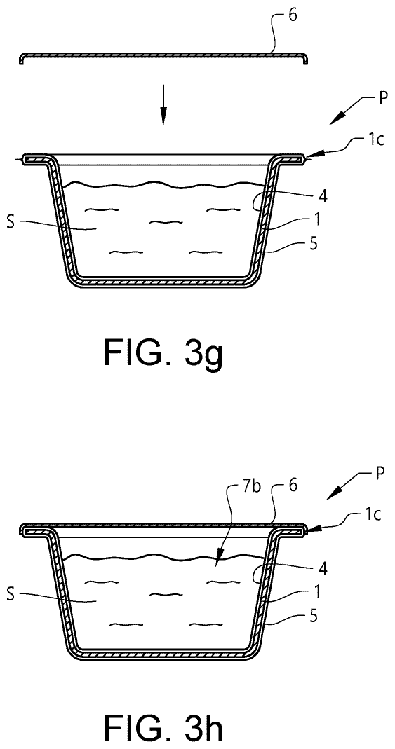

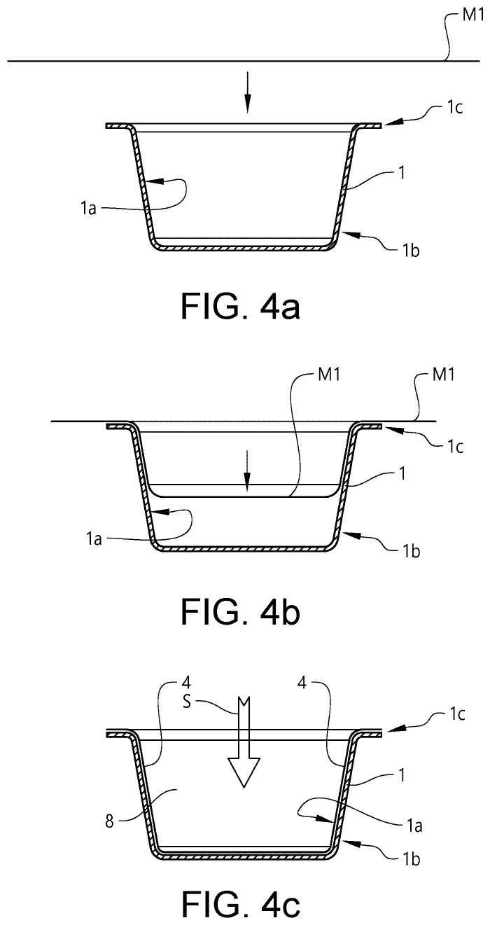

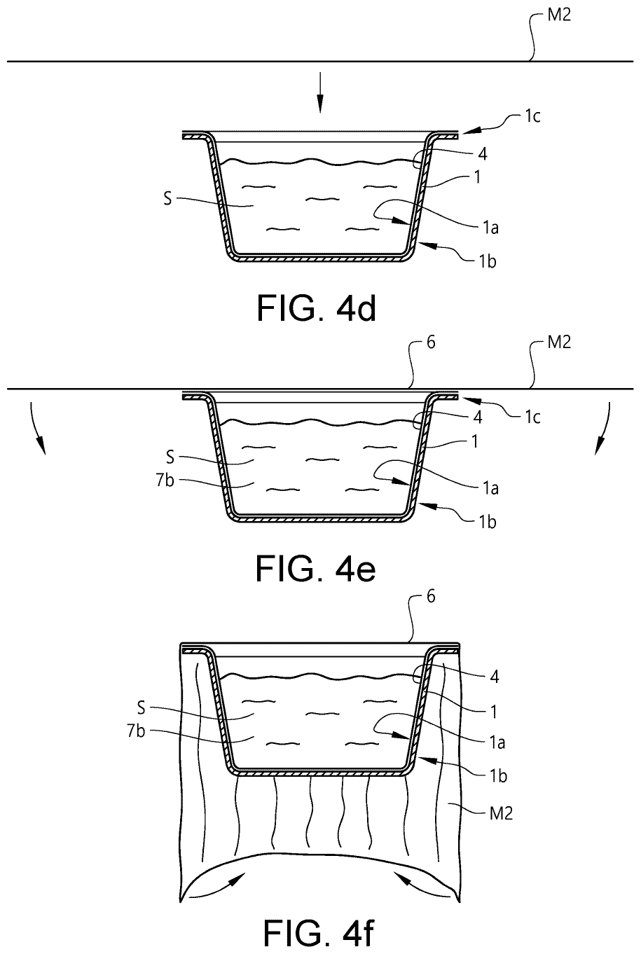

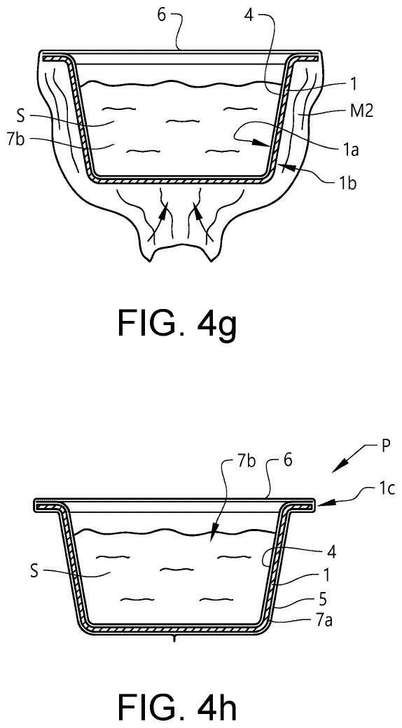

In the embodiments illustrated in FIGS. 3a-h and 4a-h, the protective inner layer 4 is formed by a first material sheet M1 and the protective outer layer 5 is formed by a second material sheet M2. Thus, the first material sheet M1 and the second material sheet M2 are formed as separate structures for the protective inner layer 4 and the protective outer layer 5 respectively, as will be further described below. With this configuration, the protective outer layer 5 is suitably attached and sealed to the protective inner layer 4 in connection to the edge structure 1c, or at the edge structure 1c, as indicated in FIGS. 3f and 4h.

In certain embodiments, the non-flat cellulose product structure 1 is dry-formed from an air-formed cellulose blank structure 2. With an air-formed cellulose blank structure 2 is meant an essentially air-formed fibrous web structure produced from cellulose fibres. The cellulose fibres may originate from a suitable cellulose raw material, such as a pulp material. Suitable pulp materials are for example fluff pulp, paper structures, or other cellulose fibre containing structures. The cellulose fibres may also be extracted from agricultural waste materials, for example wheat straws, fruit and vegetable peels, bagasse, etc. With air-forming of the cellulose blank structure 2 is meant the formation of a cellulose blank structure in a dry forming process in which the cellulose fibres are air-formed to produce the cellulose blank structure 2. When forming the cellulose blank structure 2 in the air-forming process, the cellulose fibres are carried and formed to the fibre blank structure 2 by air as carrying medium. This is different from a normal papermaking process or a traditional wet-forming process, where water is used as carrying medium for the cellulose fibres when forming the paper or fibre structure. In the air-forming process, small amounts of water or other substances may if desired be added to the cellulose fibres in order to change the properties of the cellulose product structure, but air is still used as carrying medium in the forming process. The cellulose blank structure 2 may, if suitable have a dryness that is mainly corresponding to the ambient humidity in the atmosphere surrounding the air-formed cellulose blank structure 2. As an alternative, the dryness of the cellulose blank structure 2 can be controlled in order to have a suitable dryness level when forming the cellulose product structures 1.

The air-formed cellulose blank structure 2 may be formed of cellulose fibres in a conventional air-forming process or in a blank forming module. For example, the cellulose blank structure 2 may have a composition where the fibres are of the same origin or alternatively contain a mix of two or more types of cellulose fibres, depending on the desired properties of the cellulose product structures 1. The cellulose fibres used in the cellulose blank structure 2 are during the forming process of the cellulose product structures 1 strongly bonded to each other with hydrogen bonds, due to applied forming pressure and forming temperature together with adequate moist content in the cellulose blank structure 2. The cellulose fibres may be mixed with other substances or compounds to a certain amount as will be further described below. With cellulose fibres is meant any type of cellulose fibres, such as natural cellulose fibres or manufactured cellulose fibres. The cellulose blank structure 2 may specifically comprise at least 95% cellulose fibres, or more specifically at least 99% cellulose fibres.

The air-formed cellulose blank structure 2 may have a single-layer or a multi-layer configuration. A cellulose blank structure 2 having a single-layer configuration is referring to a structure that is formed of one layer containing cellulose fibres. A cellulose blank structure 2 having a multi-layer configuration is referring to a structure that is formed of two or more layers comprising cellulose fibres, where the layers may have the same or different compositions or configurations.

The cellulose blank structure 2 may comprise one or more additional cellulose layers comprising cellulose fibres, where an additional cellulose layer for example is arranged as a carrying layer for one or more other layers of the cellulose blank structure 2. The one or more additional cellulose layers may act as reinforcement layers having a higher tensile strength than other layers of the cellulose blank structure 2. This is useful when one or more air-formed layers of the cellulose blank structure 2 have compositions with low tensile strength in order to avoid that the cellulose blank structure 2 will break during the forming of the cellulose product structures 1. The one or more additional cellulose layers with higher tensile strength act in this way as a supporting structure for other layers of the cellulose blank structure 2. The one or more additional cellulose layers may be of a different composition than the rest of the cellulose blank structure 2, such as for example a tissue layer containing cellulose fibres, an airlaid structure comprising cellulose fibres, or other suitable layer structures. It is thus not necessary that the one or more additional cellulose layers are air-formed. Other suitable additional layers may also be used such as for example silicone coated structures or bio-based films.

The one or more air-formed layers of the cellulose blank structure 2 are fluffy and airy structures, where the cellulose fibres forming the structures are arranged relatively loosely in relation to each other. The fluffy cellulose blank structures 2 are used for an efficient dry-forming of the cellulose product structures 1, allowing the cellulose fibres to form the cellulose product structures 1 in an efficient way during the forming process in a pressing module PM, as will be further described below.

In certain embodiments, the non-flat cellulose product structure 1 is wet-formed. With wet-formed is meant a wet moulding process in which water is used as carrying medium for cellulose fibres when forming the cellulose product structure 1. In the wet moulding process, the cellulose fibres, suitably originating from pulp, are mixed with water to form a fibrous slurry. The fibrous slurry is used for forming the cellulose product structures 1, and fine wire mesh moulds are shaping the cellulose product structures 1. The wet moulding process uses vacuum forming and the mesh moulds are mated with an air chamber that draws water through the mesh into the air chamber. The fibrous slurry is suitably sprayed onto the mesh moulds, and air draws the slurry tightly against the mesh. When airflow through the mesh moulds has been sufficiently blocked, the excess slurry is suitably recycled. The mesh moulds thereafter advances onward to a drying process, following by separation of the mesh mould from the cellulose product structures 1 formed from the cellulose fibres. It should be understood that any suitable wet moulding process could be used for forming the cellulose product structures 1. Wet-forming is thus different from the dry-forming of the cellulose product structure 1 described above, where the cellulose product structure 1 is formed from an air-formed cellulose blank structure 2 and air is used as carrying medium in the forming process.

In certain embodiments, one or more structural parts of the non-flat cellulose product structure 1 is dry-formed from an air-formed cellulose blank structure 2, and one or more structural parts of the non-flat cellulose product structure 1 is wet-formed. In this way, the cellulose product structure 1 may comprise two or more layers, areas or other structural parts that are formed by different forming methods. The air-forming and the wet-forming of the structural parts may be accomplished as described above, and combined or assembled into a common cellulose product structure.

To efficiently protect the cellulose product structure 1 from liquids or moisture, the protective inner layer 4 and the protective outer layer 5 are liquid impermeable or fluid impermeable. Thus, the protective inner layer 4 and the protective outer layer 5 are suitably formed from liquid impermeable or fluid impermeable materials. The protective inner layer 4 or the protective outer layer 5 are suitably arranged as an impermeable polymer film layer, an impermeable cellulose material layer, an impermeable layer formed through liquid application, or an impermeable sputter deposition layer. Suitable material configurations are for example plastic films having single-layer or multi-layer configurations; laminated, coated, or impregnated cellulose material layers including treated tissue layers; liquid substances that are forming impermeable layers through for example dip-coating or spraying; or liquid substances that are forming impermeable layers through for example filling the cellulose product structure with the liquid substance and thereafter removing excess liquid substance. Sputter deposition layers are arranged on the cellulose product structure through sputtering. Sputtering is referring to a method where thin films of a material are deposited onto a surface. By creating a gaseous plasma and then accelerating the ions from this plasma into a source material, the source material is eroded by the arriving ions via energy transfer and ejected in the form of particles, such as individual atoms, clusters of atoms or molecules. The ejected particles are deposited onto the surface and the surface is coated by a thin film of the source material.

An important requirement in selecting the protective inner layer 4 and the protective outer layer 5 for food packaging purposes is the barrier properties of the material sheets. Barrier properties include the permeability of gases, such as oxygen (O₂), carbon dioxide (CO₂), and nitrogen (N₂), water vapour, aroma compounds and light. These are examples of key factors for maintaining the quality of packaged foods.

Examples of suitable liquid or fluid impermeable materials used for the protective inner layer 4 and the protective outer layer 5 are for example plastic films made of polyethylene (PE), polyethylene naphthalate (PEN), polyvinyl alcohol (PVAL), high-density polyethylene (HDPE); polypropylene (PP), polyethylene terephthalate (PET), polyamide (PA). Bi-axially oriented films may also be used, such as bi-axially oriented polypropylene (PP-BO), bi-axially oriented polyethylene terephthalate (PET-BO), or bi-axially oriented polyamide (PA-BO). The barrier properties of plastic materials can be improved by biaxial orientation processes. Biaxial orientation results in for example increased toughness, increased stiffness, enhanced clarity, improved oil and grease resistance, and enhanced barrier properties to water vapour and oxygen.

Examples of other suitable liquid or fluid impermeable materials used for the protective inner layer 4 and the protective outer layer 5 are for example laminate materials. One example is laminates formed from two or more layers of plastic films. Another example is laminates formed of foil and plastic materials that may be utilised selectively according to specific food packaging needs. In combination, the various laminates could provide more strength and barrier protection than individual materials. Plastic film laminates or laminates of foil and plastic materials suitably rely on one or more plastic layers for heat-sealing purposes. Aluminium foil may provide a barrier to moisture, gases and light. Apart from aluminium foil, the barrier layer can consist of other barrier resins such as ethylene/vinyl alcohol (EVAL) or a barrier coating such as polyvinyl alcohol (PVAL), polyvinylidene chloride (PVDC), metallized aluminium, or one of the glass-type coatings silicon oxides (SiOₓ) or aluminium oxides (AlOₓ). The silicon oxides (SiOₓ) coatings offer an improved barrier towards oxygen, carbon dioxide and moisture, which is not affected by temperature and humidity. Transparent silicon oxides (SiOₓ) are usually coated on the surface of polymers such as polyethylene terephthalate (PET), polypropylene (PP), polyamide (PA), polyethylene naphthalate (PEN), and polyvinyl alcohol (PVAL) films. The silicon oxides SiOₓ and aluminium oxides AlOₓ may be used to replace aluminium foil.

The protective inner layer 4 and/or the protective outer layer 5 may be impermeable layers formed from laminated, coated, or impregnated cellulose material layers including treated tissue layers. Tissue layers may for example be laminated with polymer films, include polymer fibres, or alternatively be treated, coated, and/or impregnated with additives as described above.

The protective inner layer 4 and/or the protective outer layer 5 may be impermeable layers formed through liquid application. Fluorochemicals, alkyl ketene dimer (AKD), alkenyl succinic anhydride (ASA), latex, rosin (acidic sizing), wax, water glass (sodium slilcate) are all examples of agents contributing to less grease- and water absorption of the finished cellulose products P. A combination of alkyl ketene dimer (AKD) dispersion and latex dispersion may also be used when forming the protective inner layer 4 and/or the protective outer layer 5 through liquid application. The protective inner layer 4 and/or the protective outer layer 5 may for example be applied by liquid application to the cellulose blank structure 2 before forming the cellulose product structure 1 in the pressing module PM. Alternatively, the protective inner layer 4 and/or the protective outer layer 5 may be applied by liquid application to the cellulose product structure 1, where the cellulose product structure is dry-formed, wet formed, or formed by a combination of dry-forming and wet-forming.

Sputtering technology can deposit metal or non-metal films onto the surface of the cellulose product structure 1. The sputtering source materials may be metals such as for example, titanium, aluminium, platinum, silver, or copper, as well as metal oxides such as for example titanium dioxide (TiO₂), ferric oxide (Fe₂O₃), and zinc oxide (ZnO). Alternatively, the sputtering source materials may be non-metals such as for example silicon, graphite, and non-metal oxides such as silicon dioxide (SiO₂). Sputtering can also be used to deposit ceramic materials, and single or multi-layer composite nano-films formed with polymers, such as polyimide (PI) and polytetrafluoroethylene (PTFE).

The liquid impermeable or fluid impermeable materials may form layers in connection to the cellulose product structure 1 that are removable for enabling efficient recycling of the cellulose products P. Alternatively, the layers per se are recyclable, and the layers may if suitable be attached to the cellulose product structure 1 through heat application, adhesive application, or liquid application where the liquid substance may or may not be at least partly absorbed by the cellulose fibres of the interior surface 1a or the exterior surface 1b of the cellulose product structure 1.

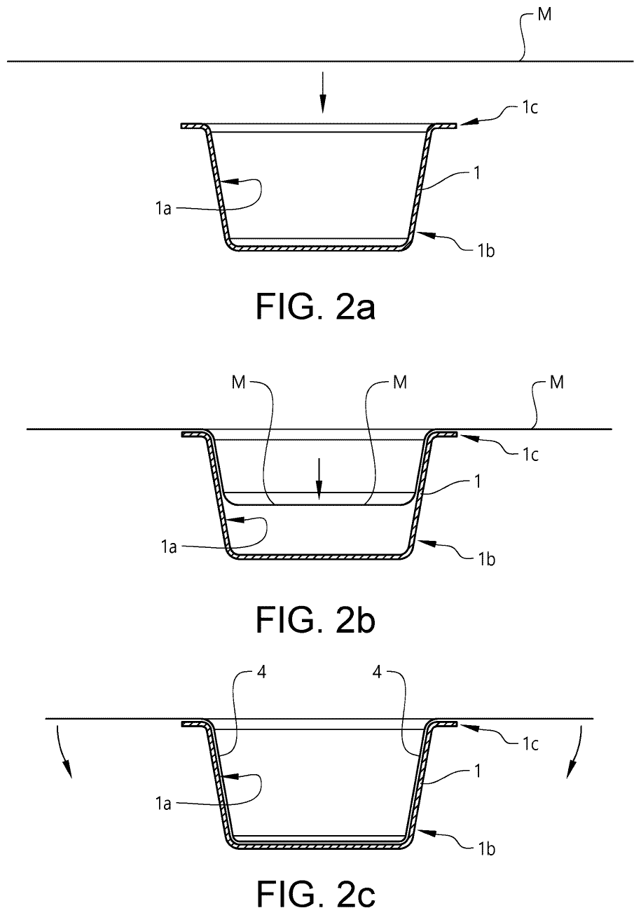

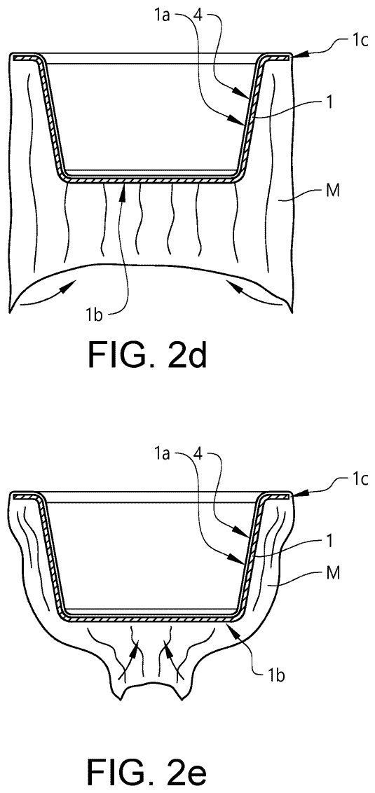

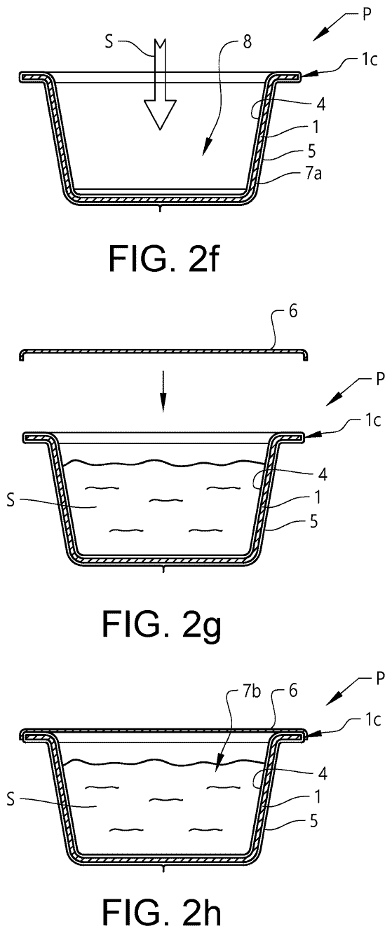

The cellulose product P suitably comprises an enclosed and sealed inner storage volume 7b. The sealed inner storage volume 7b may be arranged in different ways. In the embodiments illustrated in FIGS. 2a-h and 3a-h, the sealed inner storage volume 7b is formed between a protective cover layer 6 and the protective inner layer 4. With this configuration, the protective cover layer 6 is together with the protective inner layer 4 enclosing the sealed inner storage volume 7b, as understood from FIG. 2h, and 3h. The protective cover layer 6 is suitably arranged in connection to the protective inner layer 4 and thereafter sealed to the protective inner layer 4 with a suitable sealing method, as will be further described below. In the embodiments illustrated in FIGS. 4a-h, the sealed inner storage volume 7b is formed between a protective cover layer 6 and the protective inner layer 4. With this alternative configuration, the material sheet used for forming the protective outer layer 5 is also used for the protective cover layer 6, and the protective cover layer 6 together with the protective inner layer 4 are enclosing the sealed inner storage volume 7b, as understood from FIG. 4h. The protective cover layer 6 is suitably arranged in connection to the protective inner layer 4 and thereafter sealed to the protective inner layer 4 with a suitable sealing method, as will be further described below. Suitable materials for the protective cover layer 6 may for example be films or laminates as described above in connection to the protective inner layer 4 and the protective outer layer 5.

The cellulose product P further comprises a filling cavity 8 formed by the protective layer 4 and the interior surface 1a, as understood from the embodiments illustrated in FIGS. 2f, 3f, and 4c. The filling cavity 8 is configured for receiving a filling substance S. The filling substance S may for example be food, beverages, or other types of liquid or dry substances and goods, as schematically indicated in FIGS. 2g, 3g, and 4d for illustrative purposes. The filling cavity 8 is thus enclosed within the inner sealed storage volume 7b, as understood from the figures, and the sealed inner storage volume 7b is preventing food, beverages, or other types of liquid or dry substances and goods to come into contact with the surrounding environment for a hygienic packaging solution.

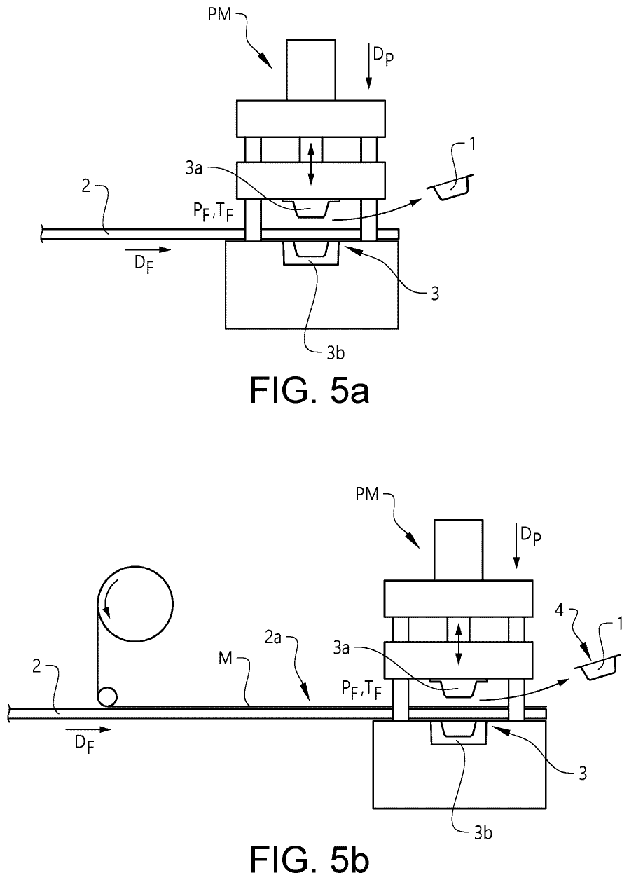

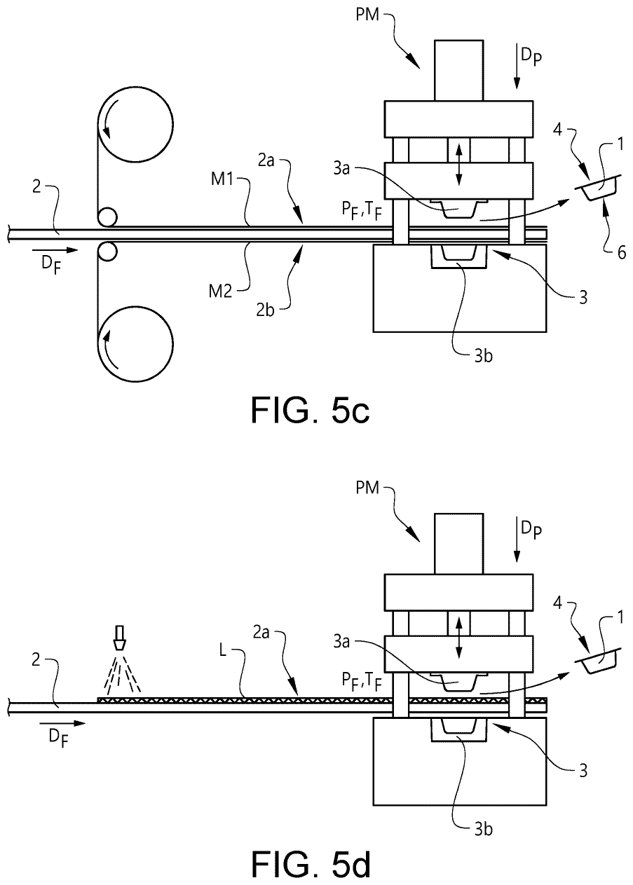

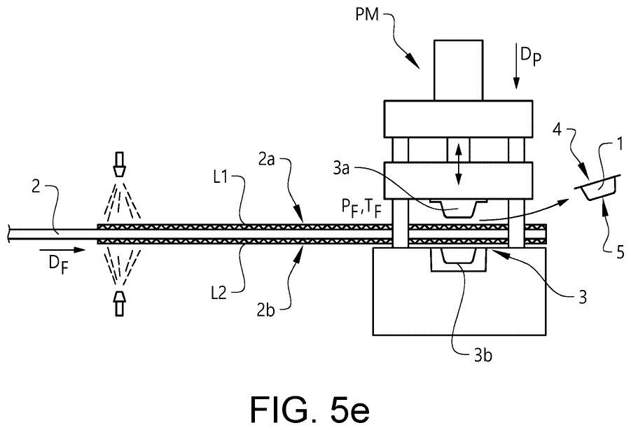

FIG. 5a schematically shows an example embodiment of a pressing module PM for dry-forming non-flat cellulose product structures 1 from a cellulose blank structure 2. The non-flat cellulose product structure 1 is as described above forming a structural part of the cellulose product P.

To form the cellulose product structures 1 from the air-formed cellulose blank structure 2 in the pressing module PM, the cellulose blank structure 2 is first provided from a suitable source. The cellulose blank structure 2 is suitably air-formed from cellulose fibres and arranged on rolls or in stacks. The rolls or stacks may thereafter be arranged in connection to the pressing module PM. As an alternative, the cellulose blank structure 2 may be air-formed from cellulose fibres directly in a blank air-forming module and fed to the pressing module PM. The cellulose blank structure 2 is fed to the pressing module PM with suitable non-illustrated transportation means, such as forming wires, vacuum belt feeders, or conveyor belts.

The pressing module PM comprises one or more forming moulds 3, and the one or more forming moulds 3 are configured for forming the cellulose product structures 1 from the cellulose blank structure 2. The pressing module PM may be arranged with only one forming mould 3 in a single-cavity configuration, or alternatively with two or more forming moulds in a multi-cavity configuration. A single-cavity configuration pressing module thus comprises only one forming mould 3 with a first mould part 3a and a cooperating second mould part 3b. A multi-cavity configuration pressing module comprises two or more forming moulds 3, each having cooperating first mould parts 3a and second mould parts 3b.

In the embodiment illustrated in FIG. 5a, the pressing module PM is arranged as a single-cavity configuration pressing module comprising one forming mould 3 with a first mould part 3a and a second mould part 3b movably arranged in relation to each other. In the following, the pressing module PM will be described in connection to a single-cavity configuration pressing module, but the disclosure is equally applicable on a multi-cavity configuration pressing module.

The pressing module PM can for example be constructed so that the first mould part 3a or the second mould part 3b is movable and arranged to move towards the other mould part during the forming process, where the other mould part is stationary or non-movably arranged. In the embodiment illustrated in FIG. 5a, the first mould part 3a is movably arranged and the second mould part 3b is stationary. In an alternative solution, both the first mould part 3a and the second mould part 3b are movably arranged, where the first mould part 3a and the second mould part 3b are displaced in directions towards each other during the forming process. The moving mould parts may be displaced with a suitable actuator, such as a hydraulic, pneumatic, or electric actuator. A combination of different actuators may also be used. The relative speed between the first mould part 3a and the second mould part 3b during the forming process is suitably chosen so that the cellulose blank structure 2 is evenly distributed in the forming mould 3 during the forming process.

As indicated in FIG. 5a, the first mould part 3a is movably arranged in relation to the second mould part 3b in a pressing direction D_{P} and the first mould part 3a is further arranged to be pressed towards the second mould part 3b during forming of the cellulose product structures 1 for establishing a forming pressure P_{F}. When forming the cellulose product structures 1, the cellulose blank structure 2 is arranged between the first mould part 3a and the second mould part 3b when the forming mould 3 is in an open state. When the cellulose blank structure 2 has been arranged in the forming mould 3, the first mould part 3a is moved in relation to the second mould part 3b during the forming process. When a suitable forming pressure P_{F} and forming temperature T_{F} is established in the forming mould 3, the movement of the first mould part 3a is stopped. The first mould part 3a is thereafter moved in a direction away from the second mould part 3b after a certain time period or directly after the first mould part 3a has been stopped. A suitable control system may be used for controlling the operation of the pressing module PM and the forming mould 3.

The cellulose product structures 1 are formed from the cellulose blank structure 2 in the forming mould 3 by heating the cellulose blank structure 2 to a forming temperature T_{F} in the range of 100-300° C., preferably in the range of 100-200° C., and pressing the cellulose blank structure 2 with a forming pressure P_{F} in the range of 1-100 MPa, preferably in the range of 4-20 MPa. The first mould part 3a is arranged for forming the cellulose product structures 1 through interaction with the corresponding second mould part 3b. During forming of the cellulose product structures 1, the cellulose blank structure 2 is arranged in the forming mould 3, between the first mould part 3a and the second mould part 3b, and exerted to the forming pressure P_{F} in the range of 1-100 MPa, preferably in the range of 4-20 MPa, and the forming temperature TF in the range of 100-300° C., preferably in the range of 100-200° C. When forming the cellulose product structures 1, strong hydrogen bonds are formed between the cellulose fibres in the cellulose blank structure 2 arranged between the first mould part 3a and the second mould part 3b, due to the applied forming pressure P_{F} and forming temperature T_{F} together with adequate moist content in the cellulose blank structure 2. The temperature and pressure levels are for example measured in the cellulose blank structure 2 during the forming process with suitable sensors arranged in or in connection to the cellulose fibres in the cellulose blank structure 2. The cellulose blank structure 2 is typically containing less than 45 weight percent water when formed in the forming mould 3.

The cellulose blank structure 2 is, as indicated in FIG. 5a, transported to the forming mould 3 in a feeding direction D_{F} with a suitable transportation speed. In order to form the cellulose product structures 1, the cellulose blank structure 2 is arranged between the first mould part 3a and the second mould part 3b. When forming the cellulose product structures 1, a force is applied to the first mould part 3a and/or the second mould part 3b, and the applied force is during the forming process establishing the forming pressure PF onto the cellulose blank structure 2.

The cellulose blank structure 2 may be arranged into the forming mould 3 in any suitable way, and as an example, the cellulose blank structure 2 may be fed with a suitable feeding device, which is transporting the cellulose blank structure 2 to the forming mould 3 in the feeding direction D_{F}. The feeding device could for example be a conveyor belt, a forming wire unit, an industrial robot, or any other suitable manufacturing equipment. The transportation speed may differ depending on the types of cellulose product structures 1 produced, and is chosen to match the forming speed in the forming mould 3.

It should be understood that the forming mould 3 may have other designs and constructions compared to the one described above, such as for example a rotary forming mould construction. The forming mould 3 may also for example be arranged with a cutting device, where the cellulose product structures 1 are cut into a desired shape in the forming mould 3 during the forming process. When the cellulose product structures 1 have been cut from the cellulose blank structure 2 in the forming process, a remaining residual cellulose fibre structure is formed. The residual cellulose fibre structure may be recycled and used again when air-forming new cellulose blank structures 2.

The cellulose products P can be produced in different ways, depending on the construction and design. In the following, examples of methods for manufacturing the cellulose product P are described. For all embodiments, the non-flat cellulose product structure 1 is provided from a suitable source, where the cellulose product structure 1 is configured with an interior surface 1a, an exterior surface 1b, and an edge structure 1c arranged between the interior surface 1a and the exterior surface 1b. The cellulose product structure 1 can be dry-formed, wet-formed, or arranged as a structure that is both dry-formed and wet-formed, as described above. The protective inner layer 4 is applied to the interior surface 1a, and the protective outer layer 5 is arranged in connection to the exterior surface 1b of the cellulose product structure 1. The protective inner layer 4 and the protective outer layer 5 are forming an integrated structure that is fully enclosing the cellulose product structure 1, and the sealed outer volume 7a is formed by the protective inner layer 4 and the protective outer layer 5.

In the embodiment illustrated in FIGS. 1a-g and 2a-h, the protective inner layer 4 and the protective outer layer 5 are formed by a single material sheet M. The same piece of single material sheet M is thus used for forming both the protective inner layer 4 and the protective outer layer 5. In this embodiment, the cellulose product structure 1 is first formed in a suitable way as described above. The protective inner layer 4 is thereafter applied to the interior surface 1a of the cellulose product structure 1, as illustrated in FIGS. 1a-c and 2a-c.

In FIGS. 1a and 2a, the single material sheet M is arranged in a position above the cellulose product structure 1, and as indicated with the arrow the single material sheet M is moved in a direction towards the cellulose product structure 1 and brought into contact with the interior surface 1a, as understood from FIGS. 1d and 2c. FIGS. 1b-c and 2b are illustrating intermediate steps for bringing the single material sheet M in contact with the interior surface 1a. The single material sheet M may for example be pushed into contact with the interior surface 1a by a suitable mechanical, pneumatic, or hydraulic pushing element, or alternatively by a stream of air. In a further alternative, the single material sheet M is drawn towards the interior surface 1a by a stream of air or other type of gas for bringing the single material sheet M into contact with the interior surface 1a. A suction force may for example be established through the cellulose product structure 1 from the interior surface 1a to the exterior surface 1b by a negative pressure or vacuum source, such as a gas suction device, to exert a force that is drawing the single material sheet M into contact with the interior surface 1a. The single material sheet M may be heat-treated to allow deformation when brought into contact with the interior surface 1a. Further, the heat-treatment may allow the single material sheet M to, at least partly, adhere to the interior surface 1a, for applying the protective inner layer 4 formed by the single material sheet M to the interior surface 1a. As an alternative, glue or other types of adhesives may be used for applying the protective inner layer 4 formed by the single material sheet M to the interior surface 1a.

When the protective inner layer 4 has been applied to the interior surface 1a, the remaining part of the single material sheet M is applied around the exterior surface 1b to form the protective outer layer 5, as illustrated in steps and indicated with arrows in FIGS. 1d-f and 2c-e. The cellulose product P with the protective inner layer 4 applied to the interior surface 1a and the protective outer layer 5 arranged in connection to the exterior surface 1b of the cellulose product structure 1, is schematically illustrated in FIGS. 1g and 2f, and the protective inner layer 4 and the protective outer layer 5 are forming an integrated structure that is fully enclosing the cellulose product structure 1.

As shown in FIGS. 1g and 2f, the sealed outer volume 7a is formed by the protective inner layer 4 and the protective outer layer 5. As shown in FIGS. 1f and 2e, the single material sheet M is applied around the exterior surface 1b, and the single material sheet M is in this way covering the exterior surface 1b. To form the protective outer layer 5, the single material sheet M is further sealed around the exterior surface 1b, for example by heat treatment, or alternatively by means of glue or other types of adhesives. The protective outer layer 5 may be heat treated, or applied with glue or other adhesives, to adhere to the exterior surface 1b for forming a cellulose product P where both the protective inner layer 4 and the protective outer layer 5 are applied to the cellulose product structure 1, as shown in FIGS. 1g and 2f.

The formed filling cavity 8 is as described above configured for receiving a filling substance S, such as food, beverages, or other types of liquid or dry substances and goods, and the filling cavity 8 is suitably filled with a filling substance S before attaching and sealing the protective cover layer 6 to the protective inner layer 4 and/or the protective outer layer 5, as indicated with the arrow in FIG. 2f. Once the filling cavity 8 has received the filling substance S, as illustrated in FIGS. 2g-h, the protective cover layer 6 is attached and sealed to the protective inner layer 4 and/or the protective outer layer 5 to form the sealed inner storage volume 7b between the protective cover layer 6 and the protective inner layer 4. The attaching and sealing of the protective cover layer 6 to the protective inner layer 4 and/or the protective outer layer 5 may for example be accomplished through application of glue or adhesive material between the layers, or heat-sealing of the layers where the layers through heat treatment or heat exposure adhere to each other. As shown in FIG. 2g, the protective cover layer 6 is suitably arranged in connection to the cellulose product structure 1 and moved in a direction towards the cellulose product structure 1 as indicated with the arrow. When the protective cover layer 6 is attached and sealed to the protective inner layer 4 and/or the protective outer layer 5, as shown in FIG. 2h, the final cellulose product P with the sealed inner storage volume 7b has been formed.

In the embodiment illustrated in FIGS. 3a-h, the protective inner layer 4 is formed by a first material sheet M1 and the protective outer layer 5 is formed by a second material sheet M2. Two different pieces of material sheet are thus used for forming the protective inner layer 4 and the protective outer layer 5 respectively. In this embodiment, the cellulose product structure 1 is first formed in a suitable way as described above. The protective inner layer 4 is thereafter applied to the interior surface 1a of the cellulose product structure 1, as illustrated in FIGS. 3a-c.

In FIG. 3a, the first material sheet M1 is arranged in a position above the cellulose product structure 1, and as indicated with the arrow the first material sheet M1 is moved in a direction towards the cellulose product structure 1 and brought into contact with the interior surface 1a, as understood from FIG. 3c. FIG. 3b is illustrating an intermediate step for bringing the first material sheet M1 in contact with the interior surface 1a. The first material sheet M1 may for example be pushed into contact with the interior surface 1a by a suitable mechanical, pneumatic, or hydraulic pushing element, or alternatively by a stream of air. In a further alternative, the first material sheet M1 is drawn towards the interior surface 1a by a stream of air or other type of gas for bringing the first material sheet M1 into contact with the interior surface 1a. A suction force may for example be established through the cellulose product structure 1 from the interior surface 1a to the exterior surface 1b by a negative pressure or vacuum source, such as a gas suction device, to exert a force that is drawing the first material sheet M1 into contact with the interior surface 1a. The first material sheet M1 may be heat-treated to allow deformation when brought into contact with the interior surface 1a. Further, the heat-treatment may allow the first material sheet M1 to, at least partly, adhere to the interior surface 1a, for applying the protective inner layer 4 formed by the first material sheet M1 to the interior surface 1a. As an alternative, glue or other types of adhesives may be used for applying the protective inner layer 4 formed by the first material sheet M1 to the interior surface 1a.

When the protective inner layer 4 has been applied to the interior surface 1a, as shown in FIG. 3c, the second material sheet M2 is applied around the exterior surface 1b to form the protective outer layer 5, as illustrated in steps and indicated with arrows in FIGS. 3d-e. When the protective outer layer 5 has been applied around the exterior surface 1b, the protective outer layer 5 is attached to the protective inner layer 4 to form the sealed outer volume 7a. The cellulose product P with the protective inner layer 4 applied to the interior surface 1a and the protective outer layer 5 arranged in connection to the exterior surface 1b of the cellulose product structure 1, is schematically illustrated in FIG. 3f, and the protective inner layer 4 and the protective outer layer 5 are forming an integrated structure that is fully enclosing the cellulose product structure 1.

As shown in FIG. 3f, the sealed outer volume 7a is formed by the protective inner layer 4 and the protective outer layer 5. As shown in FIG. 3e, the second material sheet M2 is being wrapped around the exterior surface 1b, and the second material sheet M2 is in this way covering the exterior surface 1b, as shown in FIG. 3f. To form the protective outer layer 5, the second material sheet M2 is further sealed around the exterior surface 1b, for example by heat treatment, or alternatively by means of glue or other types of adhesives. The protective outer layer 5 may be heat treated, or applied with glue or other adhesives, to form the integrated structure with the protective inner layer 4 and adhere to the exterior surface 1b for forming a cellulose product P where both the protective inner layer 4 and the protective outer layer 5 are applied to the cellulose product structure 1, as shown in FIG. 3f.

The formed filling cavity 8 is as described above configured for receiving a filling substance S, such as food, beverages, or other types of liquid or dry substances and goods, and the filling cavity 8 is suitably filled with a filling substance S before attaching and sealing the protective cover layer 6 to the protective inner layer 4 and/or the protective outer layer 5. Once the filling cavity 8 has received the filling substance S, as indicated with the arrow in FIG. 3f and further illustrated in FIGS. 3g-h, the protective cover layer 6 is attached and sealed to the protective inner layer 4 and/or the protective outer layer 5 to form the sealed inner storage volume 7b between the protective cover layer 6 and the protective inner layer 4. The attaching and sealing of the protective cover layer 6 to the protective inner layer 4 and/or the protective outer layer 5 may for example be accomplished through application of glue or adhesive material between the layers, or heat-sealing of the layers where the layers through heat treatment or heat exposure adhere to each other. As shown in FIG. 3g, the protective cover layer 6 is suitably arranged in connection to the cellulose product structure 1 and moved in a direction towards the cellulose product structure 1 as indicated with the arrow. When the protective cover layer 6 is attached and sealed to the protective inner layer 4 and/or the protective outer layer 5, as shown in FIG. 3h, the final cellulose product P with the sealed inner storage volume 7b has been formed.

In the embodiment illustrated in FIGS. 4a-h, the protective inner layer 4 is formed by a first material sheet M1 and the protective outer layer 5 is formed by a second material sheet M2. Two different pieces of material sheet are thus used for forming the protective inner layer 4 and the protective outer layer 5 respectively. In this embodiment, the cellulose product structure 1 is first formed in a suitable way as described above. The protective inner layer 4 is thereafter applied to the interior surface 1a of the cellulose product structure 1, as illustrated in FIGS. 4a-c.

In FIG. 4a, the first material sheet M1 is arranged in a position above the cellulose product structure 1, and as indicated with the arrow the first material sheet M1 is moved in a direction towards the cellulose product structure 1 and brought into contact with the interior surface 1a, as understood from FIG. 4c. FIG. 4b is illustrating an intermediate step for bringing the first material sheet M1 in contact with the interior surface 1a. The first material sheet M1 may for example be pushed into contact with the interior surface 1a by a suitable mechanical, pneumatic, or hydraulic pushing element, or alternatively by a stream of air. In a further alternative, the first material sheet M1 is drawn towards the interior surface 1a by a stream of air or other type of gas for bringing the first material sheet M1 into contact with the interior surface 1a. A suction force may for example be established through the cellulose product structure 1 from the interior surface 1a to the exterior surface 1b by a negative pressure or vacuum source, such as a gas suction device, to exert a force that is drawing the first material sheet M1 into contact with the interior surface 1a. The first material sheet M1 may be heat-treated to allow deformation when brought into contact with the interior surface 1a. Further, the heat-treatment may allow the first material sheet M1 to, at least partly, adhere to the interior surface 1a, for applying the protective inner layer 4 formed by the first material sheet M1 to the interior surface 1a. As an alternative, glue or other types of adhesives may be used for applying the protective inner layer 4 formed by the first material sheet M1 to the interior surface 1a.

When the protective inner layer 4 has been applied to the interior surface 1a, as shown in FIG. 4c, the second material sheet M2 is arranged in connection to the exterior surface 1b to form the protective outer layer 5, as illustrated in steps and indicated with arrows in FIGS. 4d-g. When arranging the protective outer layer 5 in connection to the exterior surface 1b of the cellulose product structure 1, the protective inner layer 4 and the protective outer layer 5 are forming an integrated structure that is fully enclosing the cellulose product structure 1 and a sealed outer volume 7a is formed by the protective inner layer 4 and the protective outer layer 5, as shown in FIG. 4h. The protective inner layer 4 is thus formed by the first material sheet M1 and the protective outer layer 5 is formed by the second material sheet M2. When the protective inner layer 4 has been applied to the interior surface 1a, the protective outer layer 5 is applied around the exterior surface 1b and attached to the protective inner layer 4. In this embodiment, the protective cover layer 6 is formed by the second material sheet M2 when applying the protective outer layer 5 around the exterior surface 1b, as shown in FIGS. 4e-h. An enclosed and sealed inner storage volume 7b is in this way formed between the protective cover layer 6 and the protective inner layer 4.

As shown in FIG. 4c, the interior surface 1a with the applied protective inner layer 4 is forming a filling cavity 8. Since the second material sheet M2 is forming both the protective outer layer 5 and the protective cover layer 6, the filling cavity 8 may be filled with a filling substance S, such as food, beverages, or other types of liquid or dry substances and goods, before attaching and sealing the protective cover layer 6 to the protective inner layer 4, as indicated with the arrow in FIG. 4c. Once the filling cavity 8 has received the filling substance S, as illustrated in FIGS. 4d-h, the second material sheet M2 is being wrapped around the exterior surface 1b to form the protective outer layer 5 and the protective cover layer 6.

In FIG. 4d, the second material sheet M2 is arranged in a position above the cellulose product structure 1, and as indicated with the arrow the second material sheet M2 is moved in a direction towards the cellulose product structure 1 and brought into contact with the protective inner layer 4 to form the protective cover layer 6, as understood from FIG. 4e. The part of the second material sheet M2 forming the protective cover layer 6 is attached and sealed to the protective inner layer 4 to form the sealed inner storage volume 7b between the protective cover layer 6 and the protective inner layer 4, as shown in FIG. 4e. The attaching and sealing of the protective cover layer 6 to the protective inner layer 4 may for example be accomplished through application of glue or adhesive material between the layers, or heat-sealing of the layers where the layers through heat treatment or heat exposure adhere to each other. Thereafter, the remaining part of the second material sheet M2 is used for covering the exterior surface 1b, as illustrated in steps and indicated with arrows in FIGS. 4e-g. To form the protective outer layer 5, the second material sheet M2 is sealed around the exterior surface 1b, for example by heat treatment, or alternatively by means of glue or other types of adhesives. The protective outer layer 5 may be heat treated, or applied with glue or other adhesives, to form the integrated structure with the protective inner layer 4 and adhere to the exterior surface 1b for forming a cellulose product P where both the protective inner layer 4 and the protective outer layer 5 are applied to the cellulose product structure 1, as shown in FIG. 4h.

In an alternative embodiment schematically shown in FIG. 5b, the protective inner layer 4 may instead be applied to the interior surface 1a during forming of the cellulose product structure 1 in the pressing module PM. In this embodiment, the cellulose product structure 1 is dry-formed from a cellulose blank structure 2. A single material sheet M used for forming the protective inner layer 4 is arranged in connection to a first side 2a of the cellulose blank structure 2 before the forming mould 3. During forming of the cellulose product structure 1 in the forming mould 3, the protective inner layer 4 is applied to the formed cellulose product structure 1 into the configuration illustrated in FIG. 3c. Thereafter, the protective outer layer 5 is applied around the exterior surface 1b. The attaching of the protective outer layer 5 to the protective inner layer 4 may for example be accomplished through application of glue or adhesive material between the layers, or heat-sealing of the layers where the layers through heat treatment or heat exposure adhere to each other. When the filling cavity 8 has been filled with a filling substance S, the protective cover layer 6 is attached and sealed to the protective inner layer 4 and/or the protective outer layer 5 to form the enclosed and sealed inner storage volume 7b, as described above in connection to FIGS. 3d-g. In this embodiment, the cellulose product structure 1 is dry-formed from the cellulose blank structure 2, where the cellulose blank structure 2 is provided from a suitable source and fed to the forming mould 3. The non-flat cellulose product structure 1 is formed from the cellulose blank structure 2 in the forming mould 3 by heating the cellulose blank structure 2 to the forming temperature T_{F}, and pressing the cellulose blank structure 2 with the forming pressure P_{F}. During forming, each cellulose product structure 1 is shaped with the interior surface 1a, the exterior surface 1b, and the edge structure 1c. The protective inner layer 4 is fed to the forming mould 3 with the cellulose blank structure 2 and applied to the interior surface 1a during forming of the cellulose product structure 1 from the cellulose blank structure 2 in the forming mould 3.

In an alternative embodiment schematically shown in FIG. 5c, the protective inner layer 4 is applied to the interior surface 1a and the protective outer layer 5 is applied to the exterior surface 1b during forming of the non-flat cellulose product structures 1 from a cellulose blank structure 2 in the pressing module PM. In this embodiment, the cellulose product structure 1 is thus dry-formed from a cellulose blank structure 2. A first material sheet M1 used for forming the protective inner layer 4 is fed to the forming mould 3 in connection to a first side 2a of the cellulose blank structure 2 and applied to the interior surface 1a during forming of the non-flat cellulose product structure 1 from the cellulose blank structure 2 in the forming mould 3. A second material sheet M2 used for forming the protective outer layer 5 is fed to the forming mould 3 in connection to a second side 2b of the cellulose blank structure 2 and applied to the exterior surface 1b during forming of the non-flat cellulose product structure 1 from the cellulose blank structure 2 in the forming mould 3. During forming of the cellulose product structure 1 in the forming mould 3, the protective inner layer 4 and the protective outer layer 5 are applied to the formed cellulose product structure 1 into the configuration illustrated in FIG. 3f. The attaching of the protective outer layer 5 to the protective inner layer 4 may for example be accomplished through heat-sealing of the layers where the layers through heat treatment in the forming mould 3 adhere to each other. The formed filling cavity 8 is as described above configured for receiving a filling substance S, such as food, beverages, or other types of liquid substances and goods, and the filling cavity 8 is suitably filled with a filling substance S before attaching and sealing the protective cover layer 6 to the protective inner layer 4 and/or the protective outer layer 5. Once the filling cavity 8 has received the filling substance S, as indicated with the arrow in FIG. 3f and further illustrated in FIGS. 3g-h, the protective cover layer 6 is attached and sealed to the protective inner layer 4 and/or the protective outer layer 5 to form the sealed inner storage volume 7b between the protective cover layer 6 and the protective inner layer 4.

In an alternative embodiment schematically shown in FIG. 5d, the protective inner layer 4 is applied to the interior surface 1a during forming of the cellulose product structure 1 in the pressing module PM. In this embodiment, the cellulose product structure 1 is dry-formed from a cellulose blank structure 2. The protective inner layer 4 is formed through liquid application of a layer material L to a first side 2a of the cellulose blank structure 2. The applied layer material L is forming the protective inner layer 4 in the forming mould 3, where the layer material L is adhering to the interior surface 1a. The layer material L may for example be cured in the forming process in the forming mould 3.

In an alternative embodiment schematically shown in FIG. 5e, the protective inner layer 4 and the protective outer layer 5 are applied to the interior surface 1a during forming of the cellulose product structure 1 in the pressing module PM. In this embodiment, the cellulose product structure 1 is dry-formed from a cellulose blank structure 2. The protective inner layer 4 is formed through liquid application of a first layer material L1 to a first side 2a of the cellulose blank structure 2, and the protective outer layer 5 is formed through liquid application of a second layer material L2 to a second side of the cellulose blank structure 2. The applied first layer material L1 is forming the protective inner layer 4 in the forming mould 3, and the first layer material L1 is adhering to the interior surface 1a during the forming process. The applied second layer material L2 is forming the protective outer layer 5 in the forming mould 3, and the second layer material L2 is adhering to the exterior surface 1b during the forming process. The layer materials may for example be cured in the forming process in the forming mould 3.

It should be noted that for the different embodiments, the protective inner layer 4, the protective outer layer 5, and the protective cover layer 6, may be transparent, translucent or opaque, or a combination of transparent and/or translucent and/or opaque. The respective layers can further be coloured with any suitable colour and pattern, or can be non-coloured and/or arranged without pattern.

It will be appreciated that the above description is merely exemplary in nature and is not intended to limit the present disclosure, its application or uses. While specific examples have been described in the specification and illustrated in the drawings, it will be understood by those of ordinary skill in the art that various changes may be made and equivalents may be substituted for elements thereof without departing from the scope of the present disclosure as defined in the claims. Furthermore, modifications may be made to adapt a particular situation or material to the teachings of the present disclosure without departing from the essential scope thereof. Therefore, it is intended that the present disclosure not be limited to the particular examples illustrated by the drawings and described in the specification as the best mode presently contemplated for carrying out the teachings of the present disclosure, but that the scope of the present disclosure will include any embodiments falling within the foregoing description and the appended claims. Reference signs mentioned in the claims should not be seen as limiting the extent of the matter protected by the claims, and their sole function is to make claims easier to understand.

### REFERENCE SIGNS

1: Cellulose product structure

1a: Interior surface

1b: Exterior surface

1c: Edge structure

2: Cellulose blank structure

2a: First side

2b: Second side

3: Forming mould

3a: First mould part

3b: Second mould part

4: Protective inner layer

5: Protective outer layer

6: Protective cover layer

7a: Outer volume

7b: Inner storage volume

8: Filling cavity

D_{F}: Feeding direction

D_{P}: Pressing direction

L: Layer material

M: Material sheet

P: Cellulose product

P_{F}: Forming pressure

PM: Pressing module

S: Filling substance

T_{F}: Forming temperature

1. A method for manufacturing a cellulose product, wherein the method comprises the steps:
providing a non-flat cellulose product structure, wherein the cellulose product structure comprises an interior surface, an exterior surface, and an edge structure arranged between the interior surface and the exterior surface;
applying a protective inner layer to the interior surface;
and arranging a protective outer layer in connection to the exterior surface of the cellulose product structure;
wherein the protective inner layer and the protective outer layer are forming an integrated structure that is fully enclosing the cellulose product structure, wherein a sealed outer volume is formed by the protective inner layer and the protective outer layer.

2. The method according to claim 1,
wherein the method further comprises the steps: providing an air-formed cellulose blank structure and feeding the cellulose blank structure to a forming mould; forming the non-flat cellulose product structure from the cellulose blank structure in the forming mould by heating the cellulose blank structure to a forming temperature (T_{F}), and pressing the cellulose blank structure with a forming pressure (P_{F}), wherein the cellulose product structure during forming is shaped with the interior surface, the exterior surface, and the edge structure arranged between the interior surface and the exterior surface.

3. The method according to claim 2,
wherein the method further comprises the steps: applying the protective inner layer to the interior surface and/or the protective outer layer to the exterior surface during forming of the non-flat cellulose product structure from the cellulose blank structure in the forming mould.

4. The method according to claim 2,
wherein the method further comprises the steps: applying one or more substances through liquid application and/or sputter deposition to the cellulose blank structure before forming of the non-flat cellulose product structure from the cellulose blank structure in the forming mould; forming the protective inner layer onto the interior surface and/or the protective outer layer onto the exterior surface from the applied one or more substances during forming of the non-flat cellulose product structure from the cellulose blank structure in the forming mould.

5. The method according to claim 1,
wherein the protective inner layer and the protective outer layer are formed by a single material sheet, wherein the method further comprises the steps: applying the single material sheet to the interior surface for forming the protective inner layer and applying the single material sheet around the exterior surface and the edge structure for forming the protective outer layer.

6. The method according to claim 1,
wherein the protective inner layer is formed by a first material sheet and the protective outer layer is formed by a second material sheet, wherein the method further comprises the steps: applying the first material sheet to the interior surface for forming the protective inner layer; applying the second material sheet around the exterior surface for forming the protective outer layer; and attaching the protective outer layer to the protective inner layer.

7. The method according to claim 1,
wherein the method further comprises the steps: forming the protective inner layer through liquid application or sputter deposition of a material sheet onto the interior surface, and/or forming the protective outer layer through liquid application or sputter deposition of a material sheet onto the exterior surface.

8. The method according to claim 3,
wherein the method further comprises the steps: attaching and sealing a protective cover layer to a part of the protective inner layer and/or a part of the protective outer layer, wherein an enclosed and sealed inner storage volume is formed between the protective cover layer and the protective inner layer.

9. (canceled)

10. The method according to claim 6,
wherein the method further comprises the steps: attaching and sealing a protective cover layer to a part of the protective inner layer, wherein the protective cover layer is formed by the second material sheet, wherein an enclosed and sealed inner storage volume is formed between the protective cover layer and the protective inner layer.

11. (canceled)

12. The method according to claim 1,
wherein the method further comprises the step: at least partly adhering the protective inner layer to the interior surface when applying the protective inner layer to the interior surface.

13. A cellulose product comprising a non-flat cellulose product structure, a protective inner layer, and a protective outer layer; wherein the cellulose product structure comprises an interior surface, an exterior surface, and an edge structure arranged between the interior surface and the exterior surface,
wherein the protective inner layer is applied to the interior surface, wherein the protective outer layer is arranged in connection to the exterior surface of the cellulose product structure, wherein the protective inner layer and the protective outer layer are forming an integrated structure that is fully enclosing the cellulose product structure, wherein a sealed outer volume is formed by the protective inner layer and the protective outer layer.

14. The cellulose product according to claim 13,
wherein the non-flat cellulose product structure is dry-formed from an air-formed cellulose blank structure.

15. (canceled)

16. (canceled)

17. The cellulose product according to claim 13,
wherein the protective inner layer is liquid impermeable or fluid impermeable and/or the protective outer layer is liquid impermeable or fluid impermeable.

18. The cellulose product according to claim 13,
wherein the protective inner layer and/or the protective outer layer are arranged as a polymer film layer, a cellulose material layer, a layer formed through liquid application, or a sputter deposition layer.

19. The cellulose product according to claim 13,
wherein the cellulose product further comprises an enclosed and sealed inner storage volume;
wherein the sealed inner storage volume is formed between a protective cover layer (6) and the protective inner layer.

20. The cellulose product according to claim 13,
wherein the cellulose product comprises a filling cavity formed by the protective inner layer and the interior surface, wherein the filling cavity is configured for receiving a filling substance.

21. The cellulose product according to claim 13,
wherein the protective inner layer and the protective outer layer are formed by a single material sheet.

22. The cellulose product according to claim 13,
wherein the protective inner layer is formed by a first material sheet and the protective outer layer is formed by a second material sheet.

23. The cellulose product according to claim 22,
wherein the protective outer layer is attached and sealed to the protective inner layer in connection to the edge structure, or at the edge structure.

24. The cellulose product according to claim 13,
wherein the protective inner layer is at least partly adhered to the interior surface; or wherein the protective inner layer is at least partly adhered to the interior surface and/or the edge structure.
